(19) United States
(12) Patent Application Publication
(10) Pub. No.: US 2004/0263427 A1
(43) Pub. Date: Dec. 30, 2004

(54) Lossless clock domain translation for a pixel stream

(76) Inventor: John W. Horigan, Mountain View, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/607,081

(22) Filed: Jun. 25, 2003

(51) Int. Cl. G09G 5/00

(52) U.S. Cl. 345/3.1

(57) ABSTRACT

A method and an apparatus for lossless clock domain translation for a pixel stream have been disclosed. The method includes generating a first pixel stream on a first clock signal, the first clock signal being from a first source, forwarding a second clock signal from a second source and the first pixel stream to a buffer to translate the first pixel stream into a second pixel stream on the second clock signal, and providing a feedback to the second source to cause the second source to adjust the center frequency of the second clock signal to match the average frequency of the first clock signal with the average frequency of the second clock signal.

### FIELD OF INVENTION

The present invention relates to graphic signal processing, and more particularly, to matching the average frequencies of two distinct clock signals to transmit the same graphic signal.

### BACKGROUND

It is common for a mobile computing system to be coupled to a display device, such as a cathode ray tube (“CRT”) display or monitor, in addition to the internal liquid crystal display (“LCD”) panel. The computing system can drive both the CRT display and the LCD panel with the same video image or different video images. To drive both displays with the same video images, there are currently two ways to implement it.

The first way to drive both displays with the same video image is known as twin mode. Twin mode uses a single display pipeline to generate two pixel streams, one pixel stream forwarded to each display device. The second way to drive both displays with the same video image is known as clone mode. Clone mode uses two display pipelines to generate two pixel streams, each forwarded to a distinct display device.

In general, twin mode is preferred over clone mode because twin mode uses less memory bandwidth and consumes less power. Consequently, more bandwidth is left for other purposes in twin mode. The pixel stream forwarded to the LCD panel needs spread-spectrum modulation (“SSC”) to reduce electro magnetic interference (“EMI”). SSC is a technique that continuously alters a transmission pattern by constantly changing carrier frequencies. However, having SSC in the pixel stream forwarded to a CRT monitor causes visual artifacts in the image displayed on the CRT monitor, lowering the quality of the image.

A prior method implements twin mode by generating the pixel stream with a non-SSC clock and using a buffer to translate the pixel stream into a pixel stream on a SSC clock. In other words, a pixel stream enters the buffer using the non-SSC clock but leaves the buffer using the SSC clock. Referring to FIG. 1, F_{mod} 110 is the modulation frequency of the SSC clock, which is typically in the range of 30-35 kHz. The frequency of the non-SSC clock is set to match the center frequency of the SSC clock, Fₙₒₘ 120. The corresponding pixel stream 130 on the SSC clock in the buffer 140 is also shown in FIG. 1. However, it has been observed in practice that the average frequencies of the SSC and non-SSC clocks are usually different by up to a few hundred ppm. Referring to FIG. 2, the difference is represented by Fₑᵣᵣₒᵣ 210. The difference causes the pixel stream 230 in the buffer 240 to shift upwards, and eventually, the buffer overflows at 250.

To solve the problem of buffer overflow, a prior method inserts or deletes blank pixels during the horizontal blanking period. A low voltage differential signaling (“LVDS”) interface of a chipset in a computing system has in-band horizontal and vertical synchronization information for the LCD panel to generate the LCD strobes correctly despite the varying blanking interval. However, in practice some LCD panels cannot tolerate varying blanking time because they extract a horizontal synchronization signal and a vertical synchronization signal from the blanking time and ignore the in-band versions of these signals. Furthermore, inserting or deleting blank pixels causes discontinuities in signal frequency, which adversely affects the video image quality.

### BRIEF DESCRIPTION OF THE DRAWINGS

The present invention will be understood more fully from the detailed description that follows and from the accompanying drawings, which however, should not be taken to limit the appended claims to the specific embodiments shown, but are for explanation and understanding only.

FIG. 1 shows a sample pixel stream in a buffer and the corresponding frequency.

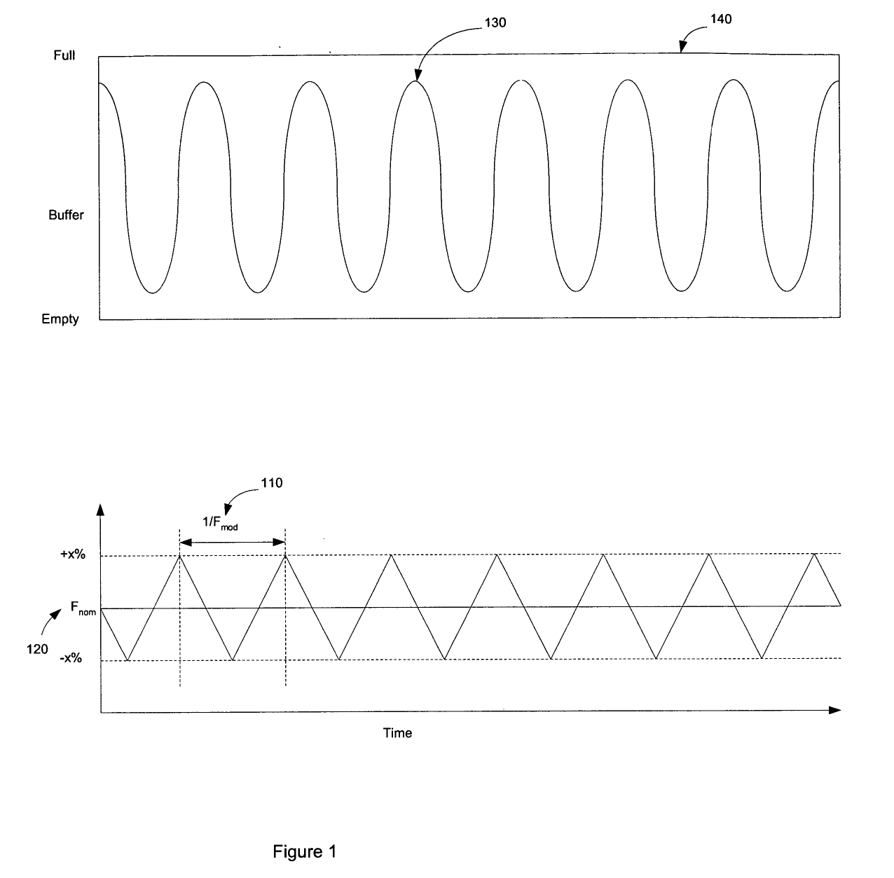

FIG. 2 shows a buffer overflows and the frequency of the pixel stream in the buffer.

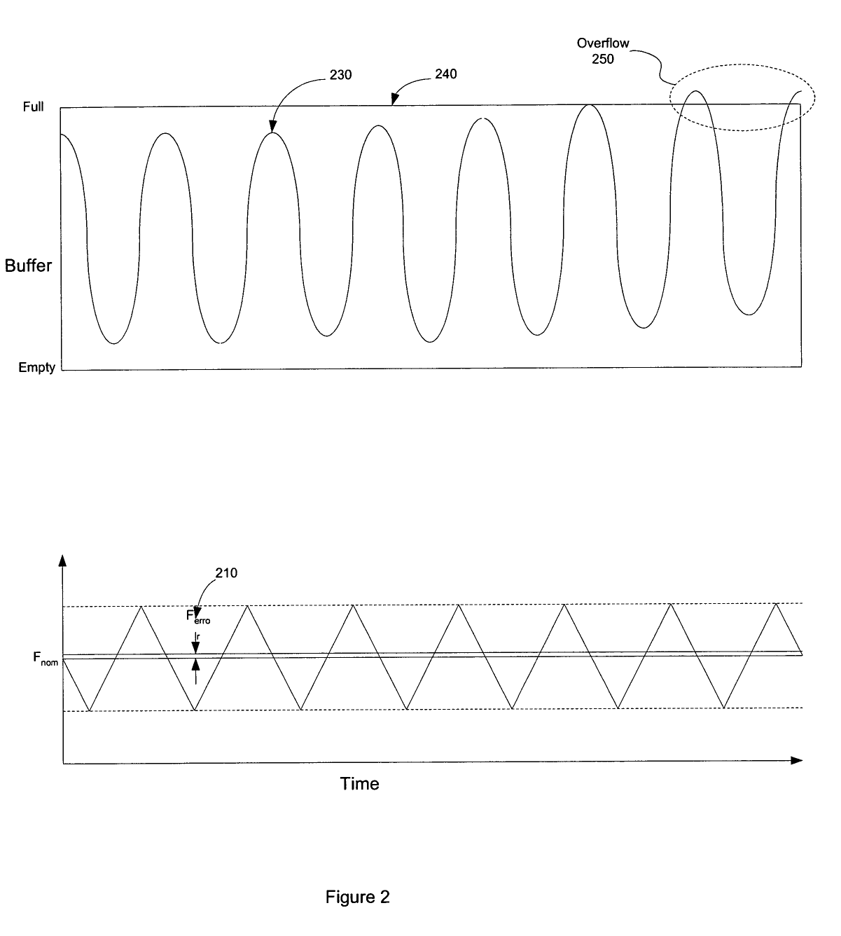

FIG. 3A shows an embodiment of a graphic memory controller hub being coupled to a system clock and a SSC clock.

FIG. 3B shows a sample pixel stream in an exemplary embodiment of a buffer and the corresponding frequency.

FIG. 3C shows a flow diagram of an embodiment of lossless clock domain translation for a pixel stream.

FIG. 4A shows an alternate embodiment of a graphic memory controller hub being coupled to a system clock and a SSC clock.

FIG. 4B shows an alternate embodiment of a graphic memory controller hub.

FIG. 5 shows one embodiment of a graphic memory controller hub being coupled to a system clock and a SSC clock.

FIG. 6 shows an embodiment of a graphic memory controller hub being coupled to a clock.

FIG. 7 shows an exemplary embodiment of a computing system.

### DETAILED DESCRIPTION

In the following description, numerous specific details are set forth. However, it is understood that embodiments of the invention may be practiced without these specific details. In other instances, well-known circuits, structures, and techniques have not been shown in detail in order not to obscure the understanding of this description.

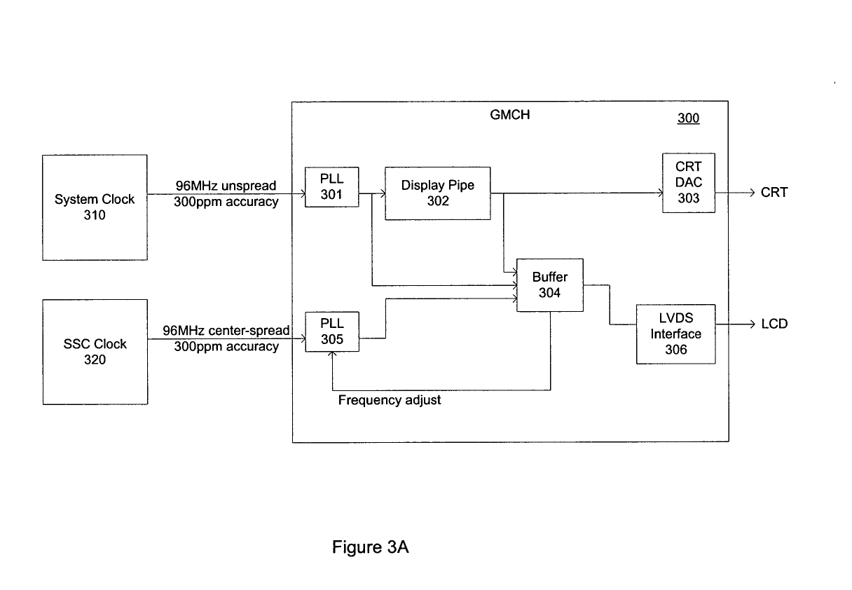

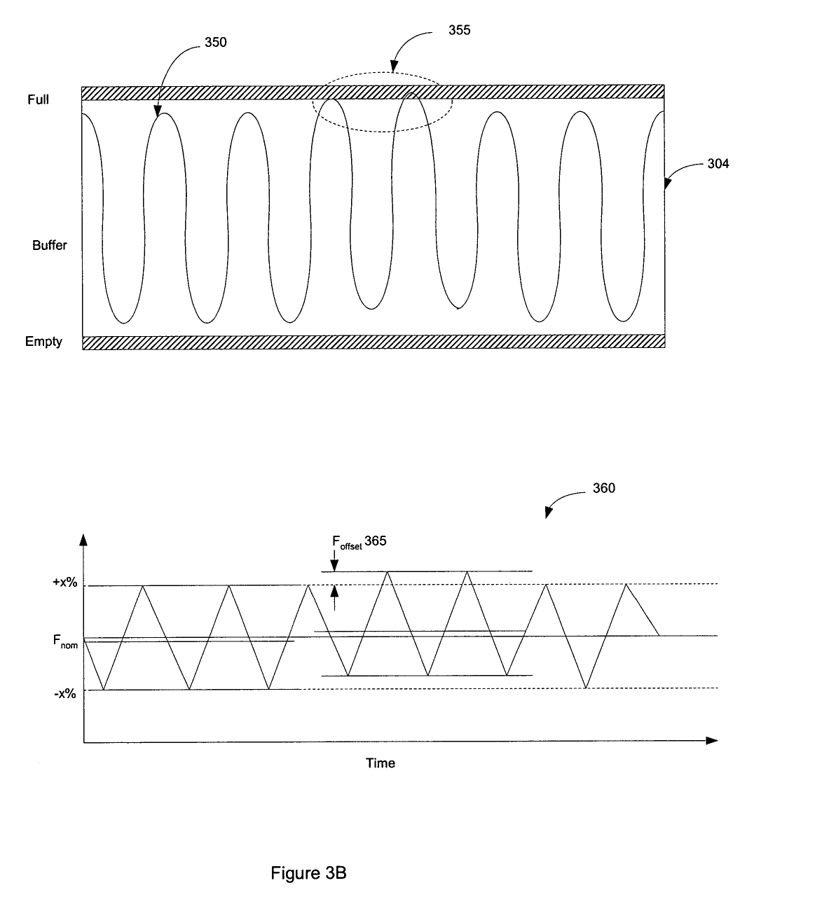

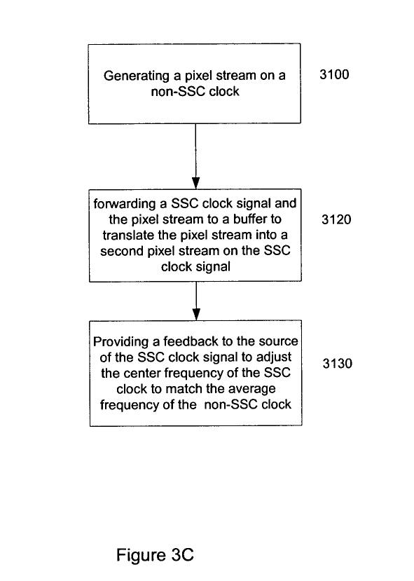

FIG. 3A shows an embodiment of a graphic memory controller hub (“GMCH”) 300 being coupled to a system clock 310 and a SSC clock 320. The system clock 310 is a non-SSC clock. In one embodiment, the system clock 310 generates a 96 MHz unspread clock signal with 300 ppm accuracy and the SSC clock 320 generates a 96 MHz center-spread signal with 300 ppm accuracy. An accuracy of 300 ppm in the SSC clock 320 means that when averaged over many SSC modulation periods, the average period of the SSC clock 320 is within 300 ppm of the period of an ideal 96 MHz clock. In an alternate embodiment, a single circuitry that generates a SSC clock and a non-SSC clock is used instead of two separate clocks. The GMCH 300 includes two phase locked loops (“PLL”) 301 and 305, a display pipe 302, a buffer 304, a CRT digital-to-analog converter (“DAC”) 303, and a LVDS interface 306. The system clock 310 generates a system clock signal and forwards the system clock signal to the PLL 301. Through the PLL 301, the system clock signal is input to the display pipe 302, which outputs a pixel stream on the system clock signal. The PLL 301 is also coupled to the buffer 304 to input the system clock signal to the buffer 304. The output of the display pipe 302 is coupled to the buffer 304 to forward the pixel stream to the buffer 304. The pixel stream is also forwarded to the CRT DAC 303. The CRT DAC 303 outputs the pixel stream on the system clock signal to a CRT display device (not shown).

The GMCH 300 also includes another PLL 305 to receive a SSC clock signal from the SSC clock 320. The PLL 305 forwards the SSC clock signal to the buffer 304. Using the SSC clock signal, the buffer 304 translates the pixel stream from the display pipe 302 into a pixel stream on the SSC clock signal. The buffer 304 is coupled to the LVDS interface 306 to forward the pixel stream on the SSC clock signal via the LVDS interface 306 to a LCD device, such as the flat panel of a notebook computer. The buffer 304 also sends a feedback signal to the PLL 305 to cause the PLL 305 to adjust the frequency of the SSC clock signal when the buffer 304 is about to overflow or underflow. The feedback signal imposes modulation on the center frequency of the SSC clock signal so that the SSC clock frequency averages out to be the same as the average frequency of the system clock signal. For example, FIG. 3B shows a sample pixel stream 350 in an exemplary embodiment of a buffer 304 and the corresponding frequency 360. The center frequency of the SSC clock is adjusted by F_{offset} 365 when the buffer is about to overflow at 355. Furthermore, the modulation allows the frequency of the SSC clock to change gradually, and therefore, there are no discontinuities in frequency. Avoiding discontinuities in frequency improves the quality of the video image rendered.

FIG. 3C shows a flow diagram of an embodiment of lossless clock domain translation for a pixel stream. The components in the system are implemented with processing logic that may comprise hardware (e.g., circuitry, dedicated logic, etc.), software (such as is run on a general purpose computer system or a dedicated machine), or a combination of both. Processing logic first generates a first pixel stream on a non-SSC clock signal (processing block 3100). Processing logic then forwards a SSC clock signal and the first pixel stream to a buffer to translate the first pixel stream into a second pixel stream on the SSC clock signal (processing block 3120). Processing logic sends a feedback to the source of the SSC clock signal to cause the source to adjust the center frequency of the SSC clock signal to match the average frequency of the non-SSC clock signal (processing block 3130). In one embodiment, the feedback is sent from the buffer to the SSC clock signal source when the buffer is about to overflow or under flow. In one embodiment, reaching a predetermined threshold value indicates that the buffer is about to overflow. Therefore, a feedback is sent to the SSC clock signal source when the predetermined threshold value is reached in the buffer. In response to the feedback, the SSC signal source adjusts the center frequency of the SSC clock signal. Adjusting the SSC clock signal center frequency accordingly prevents overflowing or under flowing the buffer. In an alternate embodiment, the feedback is sent to the SSC clock signal source from a counter. The counter counts the numbers of clock edges of both the SSC clock signal and the non-SSC clock signal and sends the feedback to the SSC clock signal source when the numbers of clock edges are different. The feedback causes the SSC clock signal source to adjust the SSC clock signal center frequency and to match the average frequency of the non-SSC clock. It should be apparent to one of ordinary skill in the art that other combinations of circuitry can be used to monitor the SSC clock frequency to provide a feedback to the SSC clock signal source. The embodiments described above are for illustrative purpose only, and should not be construed to limit the scope of the appended claims.

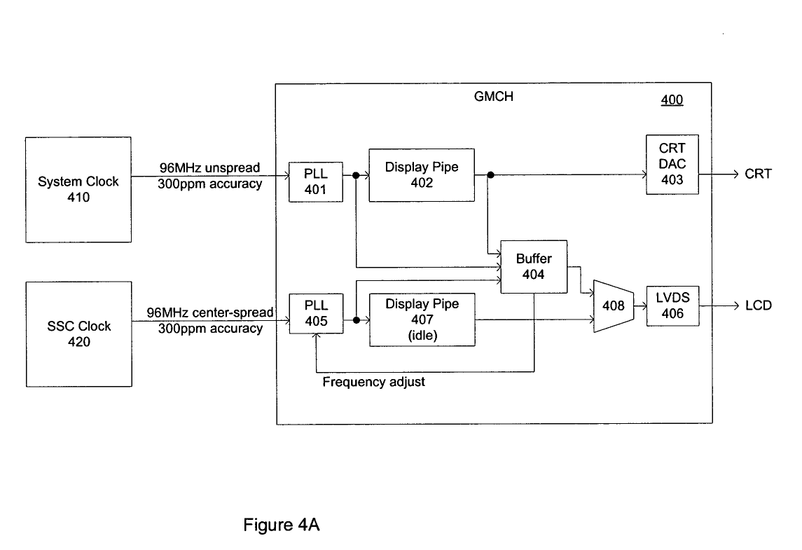

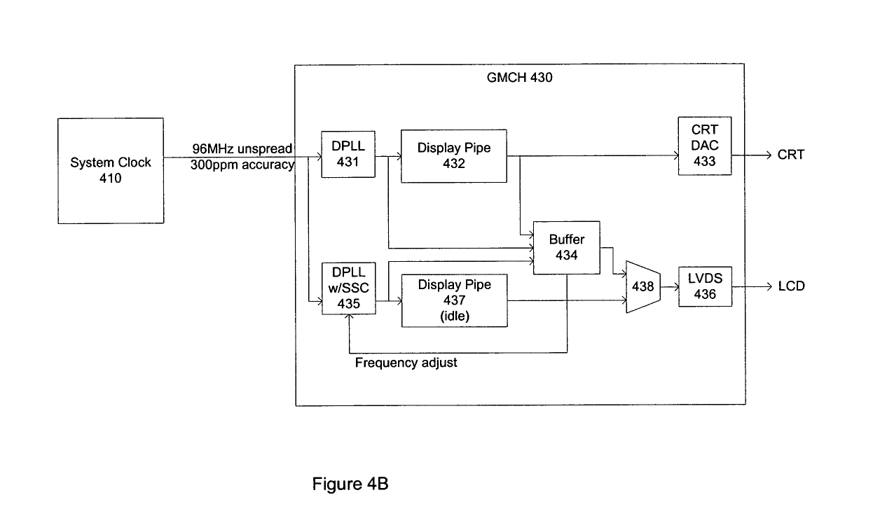

FIG. 4A shows an alternate embodiment of a GMCH 400 coupled to a system clock 410 and a SSC clock 420. The system clock 410 is a non-SSC clock. In one embodiment, the system clock 410 generates a 96 MHz unspread clock signal with 300 ppm accuracy and the SSC clock 420 generates a 96 MHz center-spread signal with 300 ppm accuracy. The GMCH 400 includes two PLLs 401 and 405, two display pipes 402 and 407, a buffer 404, a multiplexer 408, a CRT DAC 403, and a LVDS interface 406. The system clock 410 generates a system clock signal and forwards the system clock signal to the PLL 401. Through the PLL 401, the system clock signal is input to the display pipe 402, which outputs a pixel stream on the system clock signal. The PLL 401 is also coupled to the buffer 404 to input the system clock signal to the buffer 404. The output of the display pipe 402 is coupled to the buffer 404 to forward the pixel stream to the buffer 404. In addition, the pixel stream is forwarded to the CRT DAC 403. The CRT DAC 403 outputs the pixel stream on the system clock signal to a CRT display device (not shown).

The GMCH 400 includes another PLL 405 to receive a SSC clock signal from the SSC clock 420. The PLL 405 forwards the SSC clock signal to the buffer 404. Using the SSC clock signal, the buffer 404 translates the pixel stream from the display pipe 402 into a pixel stream on the SSC clock signal. The output of the buffer 404 is coupled to the multiplexer 408. The PLL 405 also forwards the SSC clock signal to the display pipe 407. The display pipe 407 generates a pixel stream on the SSC clock signal and forwards the pixel stream to the multiplexer 408. The output of the multiplexer 408 is coupled to the LVDS interface 406, which interfaces with a LCD device (not shown). When the GMCH 400 drives the LCD device and the CRT display with the same video image, the multiplexer 408 selects the pixel stream from the buffer 404 and the display pipe 407 becomes idle. When the GMCH 400 drives the LCD device and the CRT display with different video images, the display pipe 407 generates a pixel stream on the SSC clock signal and the multiplexer 408 selects this pixel stream.

In addition to translating the pixel stream, the buffer 404 sends a feedback signal to the PLL 405 to cause the PLL 405 to adjust the frequency of the SSC clock signal when the buffer 404 is about to overflow or underflow. The feedback signal imposes modulation on the center frequency of the SSC clock signal so that the SSC clock frequency averages out to be the same as the average frequency of the system clock signal.

FIG. 4B shows an alternate embodiment of a GMCH 430 coupled to a system clock 410. The system clock 410 is a non-SSC clock. In one embodiment, the system clock 410 generates a 96 MHz unspread clock signal with 300 ppm accuracy. The GMCH 430 includes two DPLLs 431 and 435, two display pipes 432 and 437, a buffer 434, a multiplexer 438, a CRT DAC 433, and a LVDS interface 436. The system clock 410 generates a system clock signal and forwards the system clock signal to the DPLL 431. Through the DPLL 431, the system clock signal is input to the display pipe 432, which outputs a pixel stream on the system clock signal. The DPLL 431 is also coupled to the buffer 434 to input the system clock signal to the buffer 434. The output of the display pipe 432 is coupled to the buffer 434 to forward the pixel stream to the buffer 434. In addition, the pixel stream is forwarded to the CRT DAC 433. The CRT DAC 433 outputs the pixel stream on the system clock signal to a CRT display device (not shown).

The GMCH 430 includes another DPLL 435 to receive the unspread system clock signal from the system clock 410. Using the unspread system clock signal, the DPLL 435 generates a SSC clock with the same average frequency as the clock signal out of the DPLL 431. The SSC clock signal is then forwarded from the DPLL 435 to the buffer 434. Using the SSC clock signal, the buffer 434 translates the pixel stream from the display pipe 432 into a pixel stream on the SSC clock signal. The output of the buffer 434 is coupled to the multiplexer 438. The DPLL 435 also forwards the SSC clock signal to the display pipe 437. The display pipe 437 generates a pixel stream on the SSC clock signal and forwards the pixel stream to the multiplexer 438. The output of the multiplexer 438 is coupled to the LVDS interface 436, which interfaces with a LCD device (not shown). When the GMCH 430 drives the LCD device and the CRT display with the same video image, the multiplexer 438 selects the pixel stream from the buffer 434 and the display pipe 437 becomes idle. When the GMCH 430 drives the LCD device and the CRT display with different video images, the display pipe 437 generates a pixel stream on the SSC clock signal and the multiplexer 438 selects this pixel stream.

In addition to translating the pixel stream, the buffer 434 sends a feedback signal to the DPLL 435 to cause the DPLL 435 to adjust the frequency of the SSC clock signal generated by the DPLL 435 when the buffer 434 is about to overflow or underflow. The feedback signal imposes modulation on the center frequency of the SSC clock signal so that the SSC clock frequency averages out to be the same as the average frequency of the system clock signal.

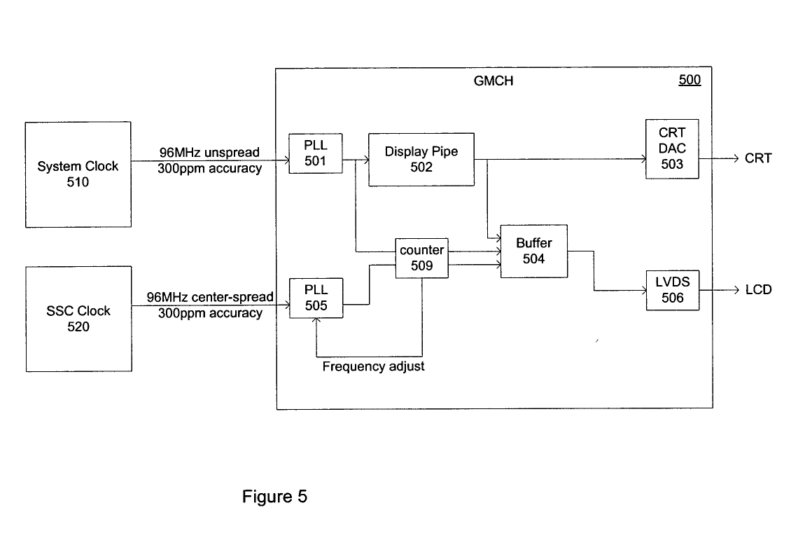

FIG. 5 shows an alternate embodiment of a GMCH 500 coupled to a system clock 510 and a SSC clock 520. The GMCH 500 includes two PLLs 501 and 505, a display pipe 502, a CRT DAC 503, a buffer 504, a LVDS interface 506, and a counter 509. The system clock 510 generates a system clock signal and forwards the system clock signal to the PLL 501. The system clock 510 is a non-SSC clock. In one embodiment, the system clock 510 generates a 96 MHz unspread clock signal with 300 ppm accuracy and the SSC clock 520 generates a 96 MHz center-spread signal with 300 ppm accuracy. Through the PLL 501, the system clock signal is input to the display pipe 502, which outputs a pixel stream on the system clock signal. The PLL 501 is also coupled to the buffer 504 to input the system clock signal to the buffer 504. The output of the display pipe 502 is coupled to the buffer 504 to forward the pixel stream to the buffer 504. The pixel stream is also forwarded to the CRT DAC 503. The CRT DAC 503 outputs the pixel stream on the system clock signal to a CRT display device (not shown).

The GMCH 500 also includes another PLL 505 to receive a SSC clock signal from the SSC clock 520. The PLL 505 forwards the SSC clock signal to the buffer 504. Using the SSC clock signal, the buffer 504 translates the pixel stream from the display pipe 502 into a pixel stream on the SSC clock signal. The buffer 504 is coupled to the LVDS interface 506 to forward the pixel stream on the SSC clock signal via the LVDS interface 506 to a LCD device, such as the flat panel of a notebook computer. The counter 509 is coupled to the output of the PLL 501 and the output of the PLL 505 to count the clock edges of the clock signal out of each PLL. When the number of clock edges of the system clock signal is different from the number of clock edges of the SSC clock signal, the counter sends a feedback signal to the PLL 505 to cause the PLL 505 to adjust the center frequency of the SSC clock signal. Keeping the counts of clock edges the same prevents overflowing or under flowing the buffer 504 because the average frequencies of the SSC clock and the system clock are kept substantially the same.

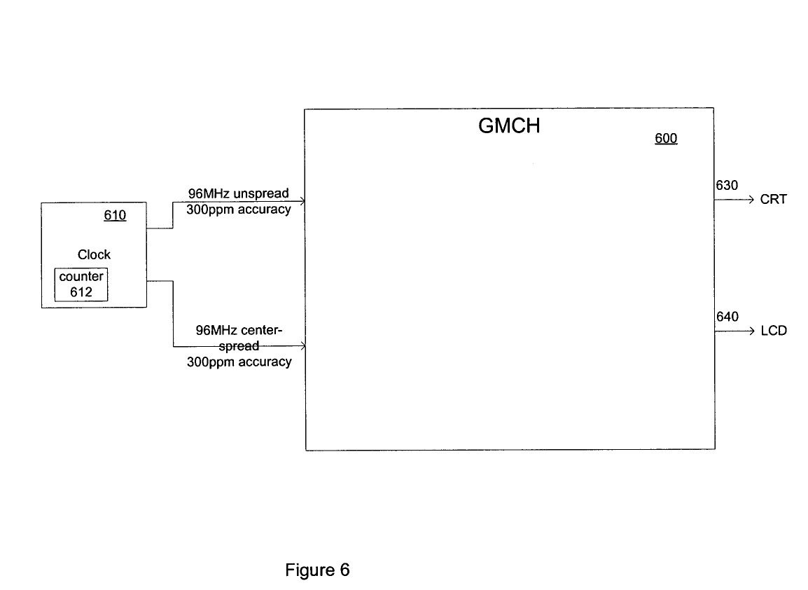

FIG. 6 shows an alternate embodiment of a GMCH 600 being coupled to a clock 610. The clock 610 generates two clock signals, one being a non-SSC clock signal and the other being a SSC clock signal. In one embodiment, the clock generates a 96 MHz unspread clock signal and a 96 MHz center-spread clock signal, both having 300 ppm accuracy. The clock 610 includes a counter 612 to count the clock edges of both clock signals. When the counts of the clock edges do not match, the clock adjusts the center frequency of the SSC clock signal so that the counts of the clock edges match each other again. The adjustment of the center frequency of the SSC clock signal makes the average frequency of the SSC clock signal and the non-SSC clock signal to be substantially the same. The two clock signals are input to the GMCH 600, which generates two pixel streams 630 and 640, one on each clock signal. The pixel stream 630 on the non-SSC clock signal is forwarded to a CRT display (not shown), and the pixel stream 640 on the SSC clock signal is forwarded to a LCD device (not shown).

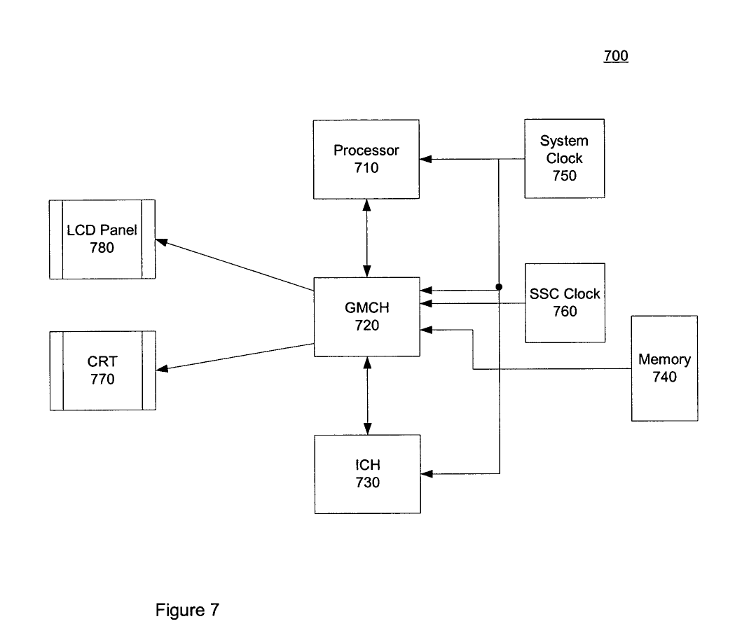

FIG. 7 shows an exemplary embodiment of a computing system 700. System 700 includes processor 710, GMCH 720, input/output controller hub (“ICH”) 730, memory 740, system clock 750, SSC clock 760, CRT display 770, and LCD panel 780. Processor 710 includes a microprocessor, but is not limited to a microprocessor, such as, for example, Pentium®, Itanium®, PowerPC®, etc. In one embodiment, memory 740 includes a dynamic random access memory (“DRAM”). In another embodiment, memory 740 includes a Rambus® dynamic random access memory (“RDRAM”), or other types of dynamic storage media. Processor 710 is coupled to GMCH 720 to transfer commands and data to and from GMCH 720. Memory 740 is coupled to GMCH 720. Data is transferred between memory 740 and the rest of system 700 via GMCH 720. ICH 730 is also coupled to GMCH 720. System clock 750 is coupled to processor 710, GMCH 720, and ICH 730 to provide them with the same system clock signal. System clock 750 is a non-SSC clock. SSC clock 760 is coupled to GMCH 720 to provide GMCH 720 with a SSC clock signal. GMCH 720 generates a pixel stream on the SSC clock signal and another pixel on the system clock signal. The output of GMCH 720 is coupled to CRT display 770 and LCD panel 780. GMCH 720 can drive CRT display 770 and LCD panel 780 with the same video image or different video images.

Note that any or all of the components described above and associated hardware may be used in various embodiments of a computing system. However, it can be appreciated that other configurations of the computing system may include some or all of the devices.

The GMCH 720 includes two PLLs, a display pipe, a buffer, a CRT DAC, and a LVDS interface. The system clock 750 generates a system clock signal and forwards the system clock signal to one of the PLL of GMCH 720. Through the PLL, the system clock signal is input to the display pipe. Using the system clock, the display pipe generates a pixel stream on the system clock signal. The PLL is also coupled to the buffer to input the system clock signal to the buffer. The output of the display pipe is coupled to the buffer to forward the pixel stream to the buffer. The pixel stream is also forwarded to the CRT DAC. The CRT DAC outputs the pixel stream on the system clock signal to CRT display 770.

GMCH 720 also includes a second PLL to receive a SSC clock signal from the SSC clock 760. The second PLL forwards the SSC clock signal to the buffer. Using the SSC clock signal, the buffer translates the pixel stream from the display pipe into a pixel stream on the SSC clock signal. The buffer is coupled to the LVDS interface to forward the pixel stream on the SSC clock signal via the LVDS interface to LCD panel 780. The buffer also sends a feedback signal to the second PLL to cause the second PLL to adjust the center frequency of the SSC clock signal when the buffer is about to overflow or underflow so that the average frequencies of both system clock 750 and SSC clock 760 are substantially the same.

The foregoing discussion merely describes some exemplary embodiments of the present invention. One skilled in the art will readily recognize from such discussion, the accompanying drawings and the claims that various modifications can be made without departing from the spirit and scope of the appended claims. The description is thus to be regarded as illustrative instead of limiting.

I claim:

1. A method comprising:
generating a first pixel stream on a first clock signal, the first clock signal being from a first source;
forwarding a second clock signal from a second source and the first pixel stream to a buffer to translate the first pixel stream into a second pixel stream on the second clock signal; and
providing a feedback to the second source to cause the second source to adjust the center frequency of the second clock signal to match the average frequency of the first clock signal with the average frequency of the second clock signal.

2. The method of claim 1, wherein providing a feedback comprises sending a signal from the buffer to the second source when the content of the buffer reaches a predetermined threshold value.

3. The method of claim 1, wherein providing a feedback comprises:
counting clock edges of the first clock signal on the first source;
counting clock edges of the second clock signal on the second source; and
sending a signal to the second source when the number of the clock edges on the first source is different from the number of the clock edges on the second source.

4. The method of claim 3, wherein the second source includes a phase lock loop.

5. The method of claim 1, wherein the first clock signal is a non-spread spectrum modulation clock signal and the second clock signal is a spread spectrum modulation clock signal.

6. The method of claim 1, further comprising:
forwarding the first pixel stream to a cathode ray tube (“CRT”) display; and
forwarding the second pixel stream to a liquid crystal display (“LCD”) panel.

7. An apparatus comprising:
a first circuitry to generate a first clock signal;
a display pipe being coupled to the first circuitry to receive the first clock signal and to generate a first pixel stream on the first clock signal;
a buffer being coupled to the display pipe to receive the first pixel stream and a second clock signal and to transform the first pixel stream into a second pixel stream on the second clock signal; and
a second circuitry being coupled to the buffer to generate the second clock signal and to receive a feedback, wherein the second circuitry adjusts the center frequency of the second clock signal in response to the feedback.

8. The apparatus of claim 7, wherein the buffer sends the feedback to the second circuitry when the buffer content reaches a predetermined threshold value.

9. The apparatus of claim 7 further comprising a counter being coupled to the first circuitry to count clock edges of the first clock signal and the second circuitry to count clock edges of the second clock signal, wherein the counter sends the feedback to the second circuitry when the number of clock edges of the first clock signal is different from the number of clock edges of the second clock signal.

10. The apparatus of claim 9, wherein the second circuitry comprises a phase lock loop.

11. The apparatus of claim 7, wherein the first clock signal is a non-spread spectrum modulation clock signal and the second clock signal is a spread spectrum modulation clock signal.

12. The apparatus of claim 7, wherein the first pixel stream is forwarded to a cathode ray tube (“CRT”) display and the second pixel stream is forwarded to a liquid crystal display (“LCD”) panel.

13. A system comprising:
a dynamic random access memory (“DRAM”);
a graphic memory controller hub being coupled to the DRAM, the graphic memory controller hub comprising
a first circuitry to generate a first clock signal;
a display pipe being coupled to the first circuitry to receive the first clock signal and to generate a first pixel stream on the first clock signal;
a buffer being coupled to the display pipe to receive the first pixel stream and a second clock signal and to transform the first pixel stream into a second pixel stream on the second clock signal; and
a second circuitry being coupled to the buffer to generate the second clock signal and to receive a feedback, wherein the second circuitry adjusts the center frequency of the second clock signal in response to the feedback.

14. The system of claim 13, wherein the buffer sends the feedback to the second circuitry when the buffer content reaches a predetermined threshold value.

15. The system of claim 13, wherein the graphic memory controller hub further comprises a counter being coupled to the first circuitry to count clock edges of the first clock signal and the second circuitry to count clock edges of the second clock signal, and to send the feedback to the second circuitry when the number of clock edges of the first clock signal is different from the number of clock edges of the second clock signal.

16. The system of claim 15, wherein the second circuitry comprises a phase lock loop.

17. The system of claim 13, wherein the first clock signal is a non-spread spectrum modulation clock signal and the second clock signal is a spread spectrum modulation clock signal.

18. The system of claim 13 further comprising a liquid crystal display (“LCD”) panel being coupled to the graphic memory controller hub to receive the second pixel stream.

19. The system of claim 18, wherein the first pixel stream is forwarded to a cathode ray tube (“CRT”) display.

20. The system of claim 13 further comprising a processor being coupled to the graphic memory controller hub.
